(19) United States
(12) Patent Application Publication
(10) Pub. No.: US 2015/0171543 A1
(43) Pub. Date: Jun. 18, 2015

(54) SEALED ELECTRICAL CONNECTOR ASSEMBLY

(71) Applicant: General Electric Company, Schenectady, NY (US)

(72) Inventors: Oscar Max Sittner, Amsterdam, NY (US); Gary William Yeager, Rexford, NY (US); Jeremy Daniel Van Dam, West Coxsackie, NY (US); Thomas Alban, Chatenoy Le Royal (FR); Benjamin Stalder, Lyon (FR)

(73) Assignee: General Electric Company, Schenectady, NY (US)

(21) Appl. No.: 14/106,011

(22) Filed: Dec. 13, 2013

(51) Int. Cl. H01R 13/52; H01R 43/24

(52) U.S. Cl. CPC H01R 13/521; H01R 43/24

(57) ABSTRACT

A connector assembly is provided that includes a connector body disposed partially or completely in a pressure vessel configured for providing electrical conductive paths into and out from the pressure vessel. The connector assembly also includes a plurality of elongated conductive pins disposed within the connector body, wherein each of the plurality of elongated conductive pins comprises a high pressure end and a low pressure end. Further, the connector assembly includes a polymeric resin disposed within the connector body to form a molded body surrounding the high pressure ends of the plurality of elongated conductive pins for providing liquid-tight and gas-tight sealing between the polymeric resin and the plurality of elongated conductive pins and between the polymeric resin and the connector body, wherein the molded body comprises a plurality of fillets around all edges of the polymeric resin.

### BACKGROUND

The present technology relates generally to electrical connectors and, more specifically, to connector assembly with electrical connections sealed from process fluids.

Generally, electrical connectors are developed to allow attachment and detachment of one or more cables connected on either side of connector pins to complete an electrical circuit. For certain applications in which electrical connections need to be reliably made from regions within a device exposed to “vastly” dissimilar thermal, compressive and/or chemical environments, such connections are challenging to achieve. One particular example is from inside to outside of a pressure vessel. Such electrical connectors have particular utility in pressure vessels where temperatures can exceed 500 degrees Fahrenheit and pressures can exceed 30,000 pounds per square inch. In such settings, various electronic components are housed within the pressure vessels and such electronics generally are designed to operate at atmospheric pressure, thereby requiring effective isolation between the high pressures of the ambient environment within the pressure vessel and the pressure within electronics modules. There is also a requirement of the use of high pressures and temperatures inside the pressure vessel, and passing electrical signals from the outside ambient conditions to electrical equipment inside the vessel. The electrical connector must provide a conductive path isolated from the thermal, compressive and/or chemical environments and effectively seal the thermal, compressive and/or chemical environments from each other. The environment inside or outside of the pressure vessel may contain elements that must not be exposed to the connector pins. Also the junction between the one or more cables and the connector pins must be protected from environmental contamination. For example, the environment inside the pressure vessel may contain corrosive elements such as hydrogen sulphide or chlorides or other electrically conductive elements such as water vapor that may reach the portion of the connector where the one or more cables are attached. This may result in a short circuit fault or loss of continuity due to corrosion of the parts within the electrical connector.

There is therefore a desire for a system and method for an enhanced technique for increased life of electrical connectors so as to prevent short circuit fault or corrosion of the parts within the electrical connectors.

### BRIEF DESCRIPTION

In accordance with an example of the technology, a connector assembly is provided that includes a connector body disposed partially or completely in a pressure vessel configured for providing electrical conductive paths into and out from the pressure vessel. The connector assembly also includes multiple of elongated conductive pins disposed within the connector body. Each of the multiple elongated conductive pins includes a high pressure end and a low pressure end. The connector assembly also includes a polymeric resin disposed within the connector body to form a molded body surrounding the high pressure ends of the multiple elongated conductive pins for providing liquid-tight and gas-tight sealing between the polymeric resin and the plurality of elongated conductive pins and between the polymeric resin and the connector body. The molded body includes multiple fillets around all edges of the polymeric resin.

In accordance with an example of the technology, a method of manufacturing a connector assembly includes disposing multiple elongated conductive pins within a connector body. The method also includes supporting the multiple elongated conductive pins within the connector body by a transverse support member having multiple passages that are insulated using glass bead seals located towards the center of the transverse support member around the multiple passages. The method further includes injecting a polymeric resin into the connector body at a high pressure side forming a molded body that surrounds the multiple elongated conductive pins for providing sealing between the polymeric resin and the multiple elongated conductive pins and between the polymeric resin and the connector body and forming multiple fillets around all edges of the polymeric resin at the high pressure side.

In accordance with an example of the technology, a sealed connector assembly includes a connector body disposed partially or completely in a pressure vessel configured for providing electrical conductive paths into and out from the pressure vessel. The connector assembly also includes multiple of elongated conductive pins disposed within the connector body. Each of the multiple elongated conductive pins includes a high pressure end and a low pressure end. The connector assembly also includes a polymeric resin disposed within the connector body to form a molded body surrounding the high pressure ends of the multiple elongated conductive pins for providing liquid-tight and gas-tight sealing between the polymeric resin and the plurality of elongated conductive pins and between the polymeric resin and the connector body. The molded body includes multiple fillets around all edges of the polymeric resin. The connector assembly further includes a polymeric covering over a junction that connects each of the multiple elongated conductor pins and each of multiple electrical cables at high pressure side of the pressure vessel, a portion of each of the multiple electrical cables with protective sheaths and a portion of each of the multiple elongated conductor pins coated with polymeric resin.

### DRAWINGS

These and other features, aspects, and advantages of the present technology will become better understood when the following detailed description is read with reference to the accompanying drawings in which like characters represent like parts throughout the drawings, wherein:

FIG. 1 is a side view, shown partially in cross section, of a connect( assembly in accordance with an example of the present technology;

FIG. 2 is a portion of a side cross section view of an exterior surface of the polymeric resin having the fillet at the corner edge with the connector body in accordance with an example of the present technology;

FIG. 3 shows a portion of a side cross section view of an exterior surface of the polymeric resin having the fillet at the corner edge with one of the multiple elongated pins in accordance with an example of the present technology;

FIG. 4 is a flow chart of a method 100 manufacturing a connector assembly in accordance with an example of the present technology.

### DETAILED DESCRIPTION

When introducing elements of various embodiments of the present technology, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed examples.

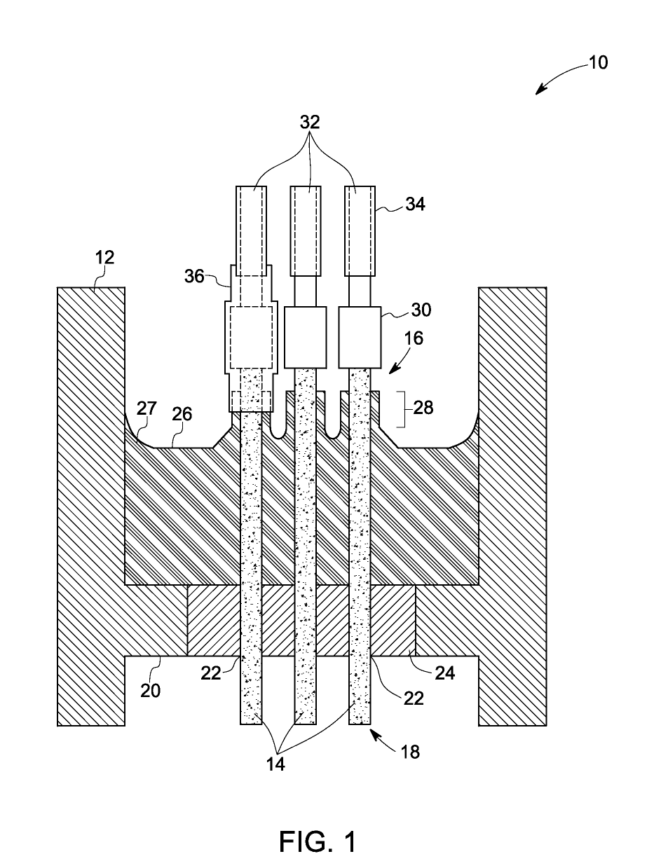

FIG. 1 is a side view, shown partially in cross section, of a connector assembly 10 having enhanced reliability and performance at elevated temperature and pressure conditions in accordance with an example of the present technology. As shown, the connector assembly 10 may be commonly found in pressure vessel applications that require electrically conductive paths into and out from such pressure vessels while simultaneously isolating high pressure one on side of the connector assembly 10 from low pressure on the other side of the connector assembly 10. In one non-limiting example, the connector assembly 10 may be used in applications that require handling of high water vapor levels and chemical contaminants. However, it will be recognized by those of ordinary skill in the art that the present technology need not be limited in application to pressure vessels, but may have application in any situation wherein a difference in environmental conditions exists across a boundary, and it is desired to pass electrical current across the boundary.

The connector assembly 10 includes a connector body 12 disposed partially or completely in a pressure vessel (not shown). In this example, the connector body 12 includes a cylindrical coupler tube made up of a metal. The connector body 12 houses multiple elongated conductive pins 14. Non-limiting examples of these multiple elongated conductive pins 14 may include copper or aluminum pins. In one example, the plurality of elongated conductor pins comprises copper or aluminum pins. The connector assembly 10 further includes a transverse support member 20 for supporting the multiple elongated conductor pins 14 within the connector body 12. As shown, the transverse support member 20 includes multiple passages 2.2 through which the multiple elongated conductive pins 14 separately pass. The transverse support member 20 also includes glass bead seals 24 around the multiple passages 22. Each of the multiple elongated conductive pins 14 includes a high pressure end 16 and a low pressure end 18. Further, the connector assembly 10 includes a polymeric resin 26 disposed within the connector body 12 to form a molded body surrounding the high pressure ends 16 of the multiple elongated conductive pins 14 for providing liquid-tight and gas-tight sealing between the polymeric resin 26 and the elongated conductive pins 14 and between the polymeric resin 26 and the connector body 12. Non-limiting examples of polymeric resins include thermoplastic, thermoset or elastomeric resin or blends thereof. Of particular interest are thermosets resins. These resins are easily processed in their uncured state, when the resin comprises unreacted monomers and/or oligomers, yet provides a thermal and mechanically stable polymeric matrix when the thermoset monomers and/or oligomers are cross-linked during cure. Typical monomers used in the formation of thermoset polymers include those compounds comprising at least one, and ideally two or more of the following functional groups: epoxy, oxetane, vinyl, acetylene, nitrile, isocyanate, amine, hydroxyl, thiol, anhydride, alkoxy, hydride, benzoxazole. Such compounds may be blended with each other and/or with catalysts or curing agents so as to facilitate crosslinking. They may be blended to produce hybrid thermoset materials or interpenetrating networks containing various types of crosslinking units. Typical examples of thermosets include epoxy, oxetane, polyester, vinyl ester, acrylate, methacrylate, maleimide, polyimide, dicyclopentadiene, acetylenic, cyanate ester, phthalocyanine, urethane, silicone, bisbenzoxazine perluorovinyl ethers resins. These thermosetting resins comprise monomers, oligomers, initiators, curatives, colorants, stabilizers, fillers (either organic or inorganic) and the like to provide an ideal balance of processability thermal, mechanical and chemical stability. The details of such thermosets may be found in a number of thermosetting materials including the epoxy casting resins produced under the trade names Durapot 861 or Stycast 2650. Also the molded body includes multiple fillets 27 around all edges of the polymeric resin 26. These multiple fillets 27 includes rounding geometry at exterior corner surfaces of the polymeric resin 26 bonded with surfaces with connector body 12 and the multiple elongated conductor pins 14.

A portion 28 of the high pressure ends 16 of the multiple elongated conductive pins 14 are coated with the polymeric resin 26. Moreover, the high pressure ends 16 of the multiple elongated conductive pins 14 include junctions 30 that connect with multiple electrical cables 32 covered with protective sheaths 34. The connector assembly 10 further includes a polymeric covering 36 over each of the junctions 30 between the multiple elongated conductor pins 14 and the multiple electrical cables 32. As shown in FIG. 1, the polymeric covering 36 extends to overlap each of the protective sheaths 34 of the multiple electrical cables 32 and the portion 28 the high pressure end 16 of each of the multiple elongated conductor pins 14 coated with polymeric resin 26 on both sides of the junction 30. Non-limiting examples of the polymeric covering 36 may include polymers or blend of polymers which exhibit an irreversible change in dimension upon external treatment. Such treatments include may be thermal or irradiative, such ultraviolet or electron beam irradiation. In one example, the polymeric covering 36 is a heat shrink tube. Such thermally activated polymers such as those used for heat shrink tubing include semicrystalline polymers. Examples of polymers used in heat shrink tubing include: fluorinated hydrocarbon polymers or copolymers produced by polymerization of a monomer or monomers comprising at least one member selected from hexafluoropropylene, vinylidene fluoride, tetrafluoroethylene and perfluoromethylvinyl ether, propylene, ethylene and therefore includes polymers such as polytetrafluoroethylene (PTFE), polyvinylidenedifluoride (PVDF, Kynar), Fluorinated poly(ethylene-co-propylene) (FEP), and copolymers sold under the trade name Viton (e.g. Viton A, B, F, GLT, GBLT, GFLT, Viton extreme). Other polymers useful for polymeric covering 36 include: polyetherketones, polyetheretherketones or polyetherketoneketones, polysiloxane polymer or copolymer, polyimide, polyamide polyvinyl chloride (PVC) and chloroprene. The polymeric covering may be cross-linked by treatment with, for example, electron beam treatment, peroxide catalysts, or moisture. Further, an adhesive within the polymeric covering 36 may include a thermally activated or cured adhesive, or an adhesive cured with UV or electron beam irradiation. Such formulations include those comprising constituents containing functionality selected from epoxy, acrylic, urethane, silicone, bismaleimide, phenolic, polyimide, polyamide, polysulfone, nitrile and blends thereof. Typical examples of useful adhesives may be found in: Adhesives Technology Handbook by Bina. Ebnesajjad® 2008, William Andrew Inc., Norwich, N.Y.

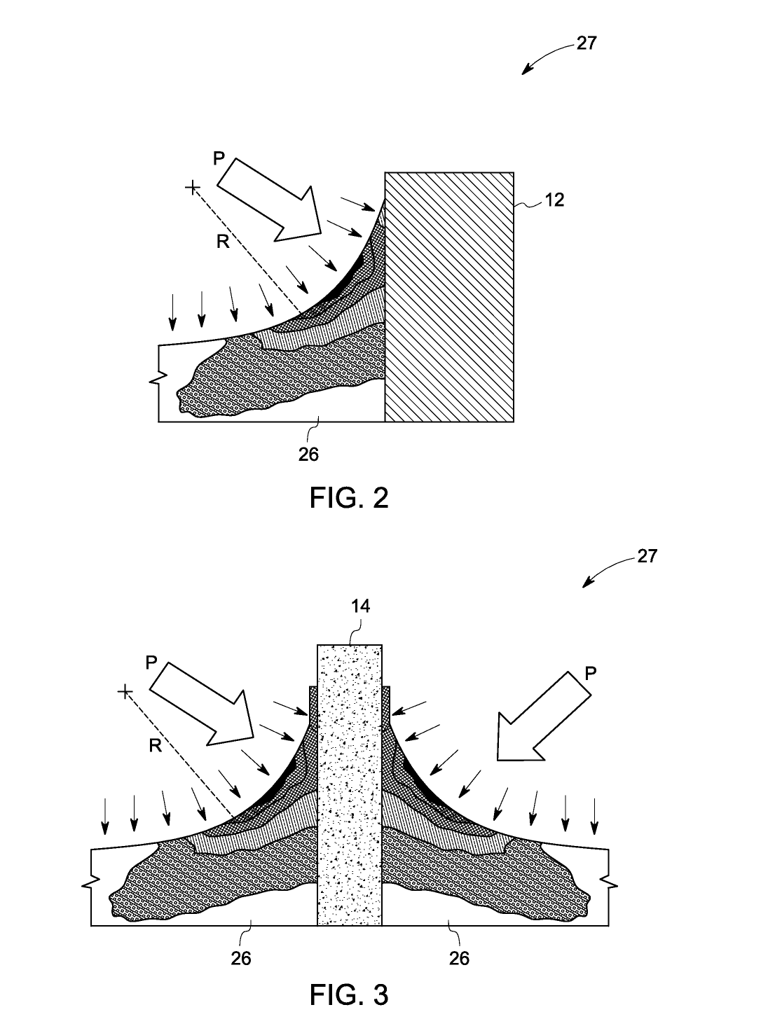

FIG. 2 is a portion of a side cross section view of an exterior surface of the polymeric resin 26 having the fillet 27 at the corner edge with the connector body 12 in accordance with an example of the present technology. At a high pressure side of the connector assembly 10 (as shown in FIG. 1), the polymeric resin 26 is bonded with the connector body 12 so as to form the fillets 27 that prevent shearing off of the polymeric resin 26. The high pressure P causes the fillets 27 to efficiently reinforce the bond, thus providing liquid-tight and gas-tight sealing between the polymeric resin 26 and the connector body 12. The contours depicted in FIG. 2 below the surface of the fillet 27 represents various levels of equivalents stresses developed due to the high pressure P and which facilitates in reinforcing the bond between the polymeric resin 26 and the connector body 12.

Similarly, FIG. 3 shows a portion of a side cross section view of an exterior surface of the polymeric resin 26 having the fillet 27 at the corner edge with one of the multiple elongated pins 14 in accordance with an example of the present technology. At a high pressure side of the connector assembly 10 (as shown in FIG. 1), the polymeric resin 26 is bonded with the elongated conductor pins 14 so as to form the fillets 27 that prevent shearing off of the polymeric resin 26. The high pressure P causes the fillets 27 to efficiently reinforce the bond, thus providing liquid-tight and gas-tight sealing between the polymeric resin 26 and the multiple elongated conductive pins 14. The contours depicted in FIG. 3 below the surface of the fillet 27 represents various levels of equivalents stresses developed due to the high pressure P and which facilitates in reinforcing the bond between the polymeric resin 26 and the elongated conductor pin 14.

During manufacturing of the connector assembly 10 (as shown in FIG. 1), in one example, a required quantity of the polymeric resin 26 is injected into the high pressure side of the connector assembly 10 and the connector body 12 is rotated leading to formations of the fillets 27. In another example, after filling the connector assembly 10 with the polymeric resin 26 at the high pressure side, a metered quantity of polymeric resin 26 is withdrawn causing formation of the fillets 27 at all edges of upper surface of the polymeric resin 26 with the surfaces of the connector body 12 and the elongated conductor pins 14. Also prior to filling the polymeric resin 26 into the connector assembly 10, the surface of the connector body 12 and the elongated conductor pins 14 are subjected to surface roughening by sandblasting or media blasting that leads to increased bonding with the polymeric resin 26. In one example, the surfaces of the connector body 12 and the elongated conductor pins 14 are subjected to machining causing formation of grooves for enhanced bonding with the polymeric resin 26. In another example, prior to injecting the polymeric resin 26 into the connector body 12 the surfaces of the connector body 12 and the elongated conductor pins 14 are oxidized such that there is a oxide layer on the surfaces which causes enhanced bonding of the polymeric resin 26 with the connector body 12 and the multiple elongated conductor pins 14. It is to be noted that the multiple fillets 27 around all edges of the polymeric resin 26 includes a radius R that is a function of a pressure of the pressure vessel P, an operating temperature within the pressure vessel, a thermal expansion coefficient difference between the polymeric resin 26 and connector body 12 or the elongated conductor pins 14, an adhesive strength of bond between the polymeric resin 26 with the connector body 12 and elongated conductor pins 14. In a non-limiting example, the radius R of each fillet may be about one tenth of the radius of cylindrical section of the connector body 12 of the connector assembly 10 (shown in FIG. 1). In a non-limiting example, the size of the cylindrical diameter of the connector body 12 may be about 4 millimeters to about 6 millimeters.

Further, at the high pressure side of the pressure vessel the electrical cables 32 are connected with the connector assembly 10 (shown in FIG. 1) by firstly exposing the conductor wires of the electrical cables 32 by removing the protective sheaths 34 before plugging into a receptacle section of the elongated conductor pins 14 followed by welding or soldering at the junction 30 (shown in FIG. 1). Thereafter, a polymeric covering 36 which includes a shrink tube with adhesive is mounted over the junction 30. The polymeric covering 36 is then heated to cause shrink fitting over the junction 30 and overlapping each of the protective sheaths 34 of the multiple electrical cables 32 and the portion 28 (as shown in FIG. 1) at the high pressure end of each of the multiple elongated conductor pins 14 coated with polymeric resin on both sides of the junction 30. Thereby, the polymeric covering 36 provides for isolated electrical conductor paths from the surroundings within the pressure vessel with process fluids having chemical contaminants at high pressure and high temperature.

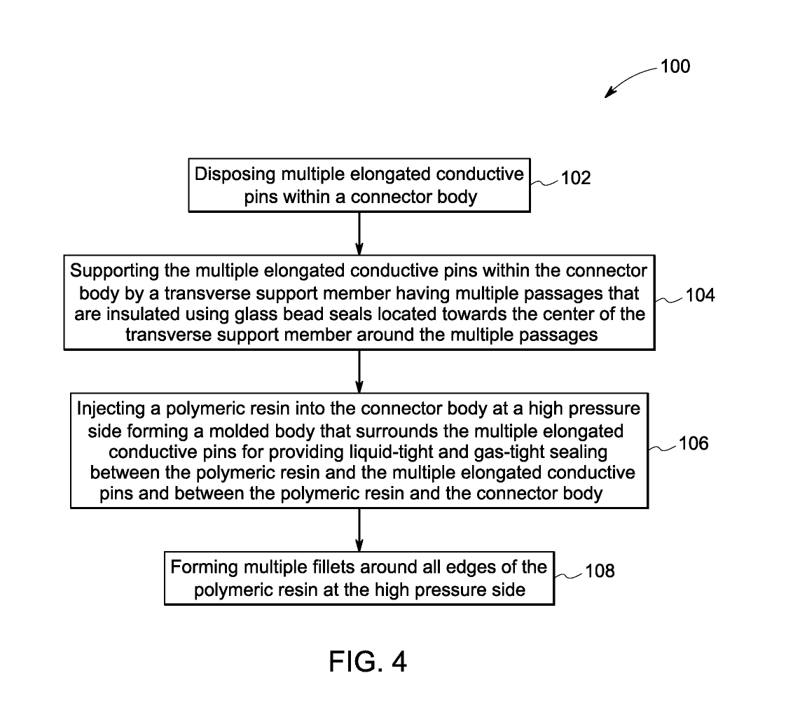

FIG. 4 is a flow chart of a method 100 manufacturing a connector assembly in accordance with an example of the present technology. At step 102, the method includes disposing multiple elongated conductive pins within a connector body. At step 104, the method also includes supporting the multiple elongated conductive pins within the connector body by a transverse support member having multiple passages that are insulated using glass bead seals located towards the center of the transverse support member around the multiple passages. At step 106, the method further includes injecting a polymeric resin into the connector body at a high pressure side forming a molded body that surrounds the multiple elongated conductive pins for providing liquid-tight and gas-tight sealing between the polymeric resin and the multiple elongated conductive pins and between the polymeric resin and the connector body. In one example, the method includes surface roughening of the connector body and the plurality of elongated conductor pins by sandblasting prior to injecting the polymeric resin into the connector body. In another example, the method also includes machining surface of the connector body and the plurality of elongated conductor pins to form grooves prior to injecting the polymeric resin into the connector body for enhanced bonding of the polymeric resin with the connector body and the plurality of elongated conductor pins. In yet another example, the method includes oxidizing the surfaces of the connector body and the plurality of elongated conductor pins to form oxide layers on surfaces prior to injecting the polymeric resin into the connector body for enhanced bonding of the polymeric resin with the connector body and the plurality of elongated conductor pins. Further, at step 108, the method includes forming multiple fillets around all edges of the polymeric resin at the high pressure side. Furthermore, the method includes providing a polymeric covering over each junction that connects each of the plurality of elongated conductor pins and each of a plurality of electrical cables at high pressure side of the pressure vessel. The polymeric covering includes a shrink tube filled with an adhesive that is heated to shrink fit over the each junction, a portion of each of the plurality of electrical cables with protective sheaths and a portion of each of the plurality of the elongated conductor pins coated with polymeric resin.

In another example, sealed connector assembly includes a sealed connector assembly having a connector body disposed partially or completely in a pressure vessel configured for providing electrical conductive paths into and out from the pressure vessel. The connector assembly includes multiple of elongated conductive pins disposed within the connector body. Each of the multiple elongated conductive pins includes a high pressure end and a low pressure end. The connector assembly also includes a polymeric resin disposed within the connector body to form a molded body surrounding the high pressure ends of the multiple elongated conductive pins for providing liquid-tight and gas-tight sealing between the polymeric resin and the plurality of elongated conductive pins and between the polymeric resin and the connector body. The molded body includes multiple fillets around all edges of the polymeric resin. The connector assembly further includes a polymeric covering over a junction that connects each of the multiple elongated conductor pins and each of multiple electrical cables at high pressure side of the pressure vessel, a portion of each of the multiple electrical cables with protective sheaths and a portion of each of the multiple elongated conductor pins coated with polymeric resin.

Advantageously, the present technology is directed towards electrical connectors that may be used to transmit electrical power and signals into and out from pressure vessels containing environmental contaminants. Further, this may result in operation of machines in pressurized environments using these electrical connectors in applications that require handling of high water vapor levels and chemical contaminants. Thus, the present technology leads to prevention of environmental contaminants to penetrate to the interior spaces of the electrical connector assembly leading to increased life of the electrical connector assemblies. Furthermore, the present technology results in improvement in scheduled product service and maintenance leading to cost saving.

Furthermore, the skilled artisan will recognize the interchangeability of various features from different examples. Similarly, the various methods and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular example. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While only certain features of the technology have been illustrated and described herein, many modifications and changes will occur to those skilled in the art. It is, therefore, to be understood that the appended claims are intended to cover all such modifications and changes as fall within the true spirit of the claimed inventions.

1. A connector assembly comprising:
a connector body disposed partially or completely in a pressure vessel configured for providing electrical conductive paths into and out from the pressure vessel;
a plurality of elongated conductive pins disposed within the connector body, wherein each of the plurality of elongated conductive pins comprises a high pressure end and a low pressure end; and
a polymeric resin disposed within the connector body to form a molded body surrounding the high pressure ends of the plurality of elongated conductive pins for providing liquid-tight and gas-tight sealing between the polymeric resin and the plurality of elongated conductive pins and between the polymeric resin and the connector body, wherein the molded body comprises a plurality of fillets around all edges of the polymeric resin.

2. The assembly of claim 1, wherein a portion of the high pressure ends of the plurality of elongated conductive pins are coated with the polymeric resin.

3. The assembly of claim 1, wherein the high pressure ends of the plurality of elongated conductive pins comprise junctions that connect with a plurality of electrical cables covered with protective sheaths.

4. The assembly of claim 3, further comprising a polymeric covering over each of the junctions between the plurality of elongated conductor pins and the plurality of electrical cables.

5. The assembly of claim 3, wherein the polymeric covering extends to overlap each of the protective sheaths of the plurality of electrical cables and the portion the high pressure end of each of the plurality of the elongated conductor pins coated with polymeric resin on both sides of the junction.

6. The assembly of claim 5, wherein the polymeric covering is a heat shrink tube containing an adhesive.

7. The assembly of claim 5, wherein the polymeric covering comprises a fluoropolymer selected from polytetrafluoroethylene (PTFE), polyvinylidenedifluoride (PVDF, Kynar), Fluorinated poly(ethylene-co-propylene) (FEP) or polyetherketones, polyetheretherketones or polyetherketoneketones, polysiloxane polymer or copolymer, polyimide, polyamide polyvinyl chloride (PVC)and chloroprene.

8. The assembly of claim 5, wherein the polymeric resin comprises a thermosetting resin epoxy casting resin such as Durapot 861 or Stycast 2650.

9. The assembly of claim 1, wherein the connector body comprises a cylindrical coupler tube made up of a metal.

10. The assembly of claim 1, wherein each of the plurality of fillets around all edges of the polymeric resin comprises a radius that is a function of a pressure of the pressure vessel, an operating temperature within the pressure vessel, a thermal expansion coefficient difference between the polymeric resin and connector body or conductor pins, an adhesive strength of bond between the polymeric resin with the connector body and conductor pins.

11. The assembly of claim 10, wherein the radius of each fillet is about one tenth of the radius of cylindrical section of the connector body.

12. The assembly of claim 1, wherien the plurality of elongated conductor pins comprises copper or aluminium pins.

13. The assembly of claim 12, wherein the plurality of elongated conductor pins are plated with non-reactive metal selected from gold or silver.

14. The assembly of claim 1, further comprising a transverse support member having a plurality of passages for supporting the plurality of elongated conductor pins within the connector body.

15. The assembly of claim 14, wherein the transverse support member comprises glass bead seals around the plurality of passages.

16. A method of manufacturing a connector assembly, the method comprising:
disposing a plurality of elongated conductive pins within a connector body;
supporting the plurality of elongated conductive pins within the connector body by a transverse support member having a plurality of passages that are insulated using glass bead seals located towards the center of the transverse support member around the plurality of passages;
injecting a polymeric resin into the connector body at a high pressure side forming a molded body that surrounds the plurality of elongated conductive pins for providing liquid-tight and gas-tight sealing between the polymeric resin and the plurality of elongated conductive pins and between the polymeric resin and the connector body; and
forming a plurality of fillets around all edges of the polymeric resin at the high pressure side.

17. The method of claim 16, further comprisng surface roughening of the connector body and the plurality of elongated conductor pins by media blasting prior to injecting the polymeric resin into the connector body.

18. The method of claim 16, further comprisng machining surface of the connector body and the plurality of elongated conductor pins to form grooves prior to injecting the polymeric resin into the connector body for enhanced bonding of the polymeric resin with the connector body and the plurality of elongated conductor pins.

19. The method of claim 16, further comprisng oxidizing the surfaces of the connector body and the plurality of elongated conductor pins to form oxide layers on surfaces prior to injecting the polymeric resin into the connector body for enhanced bonding of the polymeric resin with the connector body and the plurality of elongated conductor pins.

20. The method of claim 16, further comprising providing a polymeric covering over each junction that connects each of the plurality of elongated conductor pins and each of a plurality of electrical cables at high pressure side of the pressure vessel.

21. The method of claim 20, wheriein the polymeric covering comprises a shrink tube filled with an adhesive that is heated to shrink fit over the each junction, a portion of each of the plurality of electrical cables with protective sheaths and a portion of each of the plurality of the elongated conductor pins coated with polymeric resin.

22. A sealed connector assembly comprising:
a connector body disposed partially or completely in a pressure vessel configured for providing electrical conductive paths into and out from the pressure vessel;
a plurality of elongated conductive pins disposed within the connector body, wherein each of the plurality of elongated conductive pins comprises a high pressure end and a low pressure end;
a polymeric resin disposed within the connector body to form a molded body surrounding the high pressure ends of the plurality of elongated conductive pins for providing liquid-tight and gas-tight sealing between the polymeric resin and the plurality of elongated conductive pins and between the polymeric resin and the connector body, wherein the molded body comprises a plurality of fillets around all edges of the polymeric resin; and
a polymeric covering over a junction that connects each of the plurality of elongated conductor pins and each of a plurality of electrical cables at high pressure side of the pressure vessel, a portion of each of the plurality of electrical cables with protective sheaths and a portion of each of the plurality of the elongated conductor pins coated with polymeric resin.

23. The assembly of claim 22, wherein each of the plurality of fillets around all edges of the polymeric resin comprises a radius that is a function of a pressure of the pressure vessel, an operating temperature within the pressure vessel, a thermal expansion coefficient difference between the polymeric resin and connector body or conductor pins, an adhesive strength of bond between the polymeric resin with the connector body and conductor pins.
